(19) United States
(12) Patent Application Publication
(10) Pub. No.: US 2007/0074157 A1
(43) Pub. Date: Mar. 29, 2007

(54) Method and system for runtime graphical assembly of running applications

(75) Inventors: Christopher D. Worden, Fort Lauderdale, FL (US); Ole Pederson, Fort Lauderdale, FL (US); Ken Gilb, Fort Lauderdale, FL (US)

Correspondence Address: ARENT FOX PLLC, 1050 CONNECTICUT AVENUE, N.W., SUITE 400, WASHINGTON, DC, 20036, US

(73) Assignee: WDN Holdings, LLC

(21) Appl. No.: 11/403,962

(22) Filed: Apr. 14, 2006

Related U.S. Application Data
(60) Provisional application No. 60/719,560, filed on Sep. 23, 2005.

(51) Int. Cl. G06F 9/44

(52) U.S. Cl. 717/109; 717/113; 717/105

(57) ABSTRACT

A method and system for dynamic management of running applications and the communications among them at runtime. Runtime dynamic assembly of running applications is achieved by providing graphical representations of the running software applications in block form, and dynamically connecting the blocks into a flow chart, each application being instantiated into a running object upon inclusion in the flow chart. The method and system of the present invention provide dynamic common access and/or a dynamic common interface to source code programs authored by different programmers at runtime, while enabling changing of existing software applications without the need for recompilation of the code. Further, the method and system of the present invention enable changing of existing running software solutions without the need for interrupting the execution of the software.

### CROSS-REFERENCE TO RELATED APPLICATIONS

The present utility application claims priority and is related to U.S. Provisional Application Ser. No. 60/719,560, filed September 23, the entirety of which is incorporated by reference herein.

### BACKGROUND OF THE INVENTION

1. Field of the Invention

The present invention relates to a method and system for runtime dynamic management of running applications and the communications among them. Specifically, the present invention relates to the graphical presentation of instantiated objects and the creation of connections among them, at the selection of the user, while the instantiated objects are running.

2. Background of the Related Art

One problem in the software industry today is that it is not practicable to provide dynamic common access and/or a dynamic common interface to source code programs authored by different software developers, while the programs are running. Traditionally, software has been created by programmers as a finite solution for end users. User-specified customization or other changes in the original software typically require the changes to be made in the source code by a software developer, reassembly and recompilation of the software, and redistribution of the customized program to the end user. Any such customization requires at least the following: (a) involvement by a skilled and trained software developer; (b) recompilation of the software; and (c) interruption in program execution.

There are known in the art methods and systems that enable an end user, rather than a software developer, to perform software customization. For example, graphical or iconic programming languages (also known as “environments”) permit an end user, through manipulation of a graphical diagram, to instruct a system to create and/or generate software code of behalf of the user, thus requiring little low level text-based programming experience. Examples of such graphical programming environments include Visual Basic, Delphi, Vee, LabView and DT Measure Foundry, including Visual Basic—made by Microsoft® Corporation of Redmond, Wash., Delphi—made by Borland—Software Corporation of Cupertino, Calif., Vee—made by Agilent Technologies, Inc., of Palo Alto, Calif., LabVIEW—made by National Instruments® Corporation of Austin, Tex., and DTMauseure Foundry—made by Data Translation®, Inc., of Marlboro, Mass., among others. All of these environments, however, require at least two modes: a development mode and a runtime mode, during which the developed and assembled program is compiled for loading and running (e.g., on a computer operating system, micro device, instrument, embedded hardware, virtual device or virtual operating system). Thus, while these graphical environments purport to allow end users to perform customization of existing programs by in essence providing a substitute for a trained software developer, they fail to avoid the necessity for pre-runtime recompilation of software upon making changes, and for program execution interruption to make the changes and recompile the program.

An additional shortcoming of these graphical programming environments is that they are not attractive to traditional software developers, being typically limited by pre-defined graphical representations of instructions. Furthermore, while these environments purport to allow end users to create complete solutions, these solutions are frequently inefficient. In addition, such environments require end users to learn some traditional programming constructs, such as loops, conditionals, and variables, among others. Moreover, all graphical programming environments involve creation of software code in the background, on behalf of the end user, without permitting the end user to take advantage of the actual knowledge, experience and skill of trained software developers in resolving a particular problem.

Other shortcomings of known graphical software environments include the fact that most graphical languages are proprietary and require translation from an existing algorithm to a specific iconic language implementation. Also, making changes to a program typically requires switching from a runtime mode for execution of the program, to a development mode for manipulation of the program flow, and vice versa. In addition, any program in a runtime mode must be terminated prior to switching to the development and assembly mode to make changes in the software.

There is a general need in the art, therefore, for methods and systems that provide dynamic common access and/or a dynamic common interface to source code programs authored by different programmers at runtime. There is a further need in the art for methods and systems that enable making changes to existing software programs without the need for recompilation. There is yet a further need for methods and systems that enable making changes to existing running software solutions without the need for interrupting the execution of the software. Finally, there is a need in the art for methods and systems that permit end users to take advantage of the skills of software developers in resolving specific problems by combining different available software applications, while the software applications are in a state of execution, thereby providing an attractive solution to beginners and skilled software developers alike.

### SUMMARY OF THE INVENTION

The present invention solves the above identified needs, and others, by providing a method and system for runtime dynamic management of running applications and the communications among them. The present invention permits runtime dynamic assembly of running applications by providing graphical representations of the running software applications in, e.g., block form, and dynamically connecting the blocks in a block diagram, each application being instantiated into a running object upon inclusion in the diagram. One of ordinary skill in the art will appreciate, however, that the graphical representation of compiled software applications may, besides in block form, be represented in any shape, form, or visual element.

Embodiments of the method and system of the present invention provide dynamic common access and/or a dynamic common interface to source code programs authored by different programmers at runtime. In addition, embodiments of the present invention enable making changes to, including adding and subtracting, existing software applications without the need for recompilation of the code. Further, embodiments of the present invention enable making changes to existing running software solutions without the need for interrupting the execution of the software. Moreover, embodiments of the present invention permit end users to take advantage of the skills of software developers in resolving specific problems by combining different available software applications, while the software applications are in a state of execution.

Other objects, features, and advantages will be apparent to persons of ordinary skill in the art from the following detailed description of the invention and the accompanying drawings.

### BRIEF DESCRIPTION OF THE FIGURES

For a more complete understanding of the present invention, the needs satisfied thereby, and the objects, features, and advantages thereof, reference now is made to the following description taken in connection with the accompanying drawings.

FIG. 1 presents a flow diagram of functions performed in accordance with an embodiment of the present invention.

FIGS. 2A-2P show Graphical User Interface (“GUI”) screens depicting an example scenario for the task of performing a calculator from the point of view of a user of the system, in accordance with an embodiment of the present invention.

FIGS. 3A-3G show GUI screens depicting an example scenario for the task of performing a pong game from the point of view of a user of the system, in accordance with an embodiment of the present invention.

FIGS. 4A-4B show GUI screens depicting an example scenario for the task of performing a statistical stock chart, in accordance with an embodiment of the present invention.

FIG. 5 contains a block diagram of various computer system components for use with an exemplary implementation of a system for runtime dynamic management of running applications and the communications among them, in accordance with an embodiment of the present invention.

FIG. 6 presents an exemplary system diagram of various hardware components and other features in accordance with an embodiment of the present invention.

FIG. 7 presents an example open system architecture, in accordance with an embodiment of the present invention.

### DETAILED DESCRIPTION

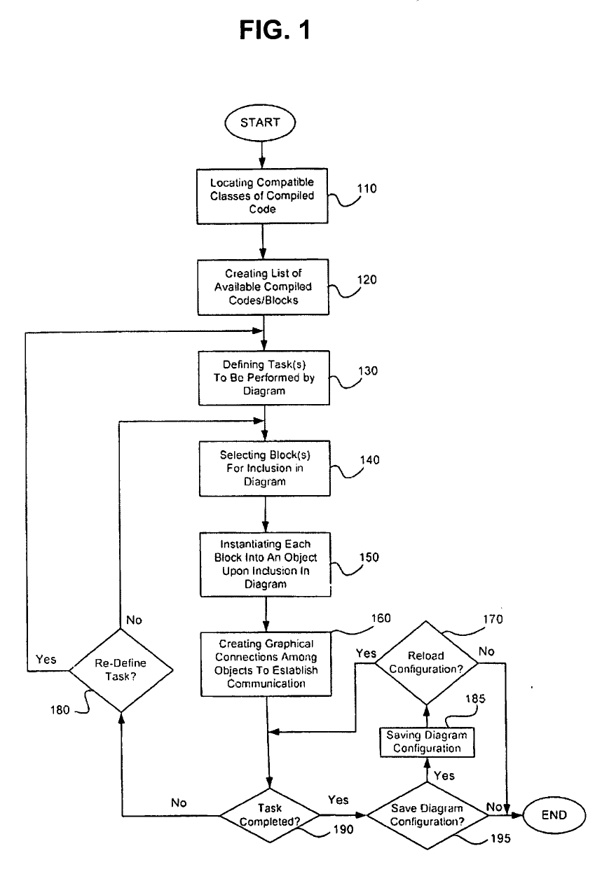

Preferred embodiments of the present invention and their features and advantages may be understood by referring to FIGS. 1-7, like numerals being used for like corresponding parts in the various drawings.

In one embodiment, the system and method of the present invention for dynamic assembly of running applications and the connections among them while running, may be implemented as an Internet-based or other network-based system that allows the end user unlimited or virtually unlimited flexibility in terms of the types of compatible source code applications that may be connected to each other to form a graphical assembly of one or more instantiated objects or running blocks and the connections among them (alternatively referred to herein as a diagram, flow chart or graphical representation), and in terms of connecting functioning (previously or simultaneously created) diagrams, such as by nesting diagrams within each other and/or connecting blocks and flow charts in a number of possible ways. To facilitate the understanding of the description that follows, it is assumed that each source code application is previously compiled by its respective developer. One of ordinary skill in the art will understand, however, that such applications may be compiled at any point prior to their inclusion in a diagram as instantiated objects while running.

An example flow diagram of functions performed in accordance with an embodiment of the present invention will now be described in reference to FIG. 1. After locating compatible classes of compiled code 110, one embodiment of the method for dynamically managing running applications and their connections while running includes creating a list of available compiled codes 120 for inclusion into diagrams in the form of graphical blocks. It will be recognized by those skilled in the art that the compiled code may be supplied from or in any device or system capable of supplying compiled code, such as a network (e.g., the Internet), a server, or any local, wired or wireless storage medium. It will also be recognized by those skilled in the art that a class is a definition of an object, and is made up of the software code. To use an object, a user must instantiate an instance of the class. Therefore, if 50 television objects are needed, 50 instances of the television class should be provided. Each of the 50 instances is created by instantiation. According to accepted terminology in the art, to reduce ambiguity, classes are “created,” while objects are “instantiated.” Class creation is performed at design time when the software is being built, and involves writing the actual software code. Objects are instantiated at runtime when the program is being used. See, e.g., Thearon Willis, Jonathan Crossland & Richard Blair, Beginning VB.NET 2003 327 (Wiley Publishing, Inc.) (2004).

Referring now to FIG. 1, upon creation of a list of available compiled codes 120, a user (e.g., an “end user”) defines one or more tasks to be performed by one or more diagrams 130 to be created through any combination of the available compiled codes (interchangeably referred to herein as “blocks”).

One or more compatible classes from compiled code or blocks are then selected from the list for inclusion into the diagram 140. Upon selection and inclusion of each block into the diagram, the block is instantiated into an object and begins to execute 150. Graphical connections may then be created between/among the instantiated blocks, whereupon communications are established between/among the instantiated blocks 160, while the blocks are executing. It will be recognized by those skilled in the art that the graphical connections may be created by any available user input device, such as a keyboard or mouse. It will also be recognized by those of ordinary skill in the art that communications among the instantiated objects may be established by creating one or more references among the objects, such as execution address pointers. Further, references may be established among diagrams, if one or more diagrams are being connected to complete a task, or may be brokered by a first instantiated object to facilitate an indirect connection between a second and a third instantiated objects.

In one embodiment, upon creating the graphical connections among instantiated objects to establish communication 160, the method of the present invention is complete, if the task to be performed by the diagram has been completed 190 and the user does not wish to save 195 the current diagram configuration, or saves the configuration 185, but does not wish to reload it 170. Furthermore, the diagram and connections may be saved in XML format, or in any other format capable of storing the type of data represented by the objects and connections. The instantiated objects may be saved, for example, as instance identifiers, such as Globally Unique Identifiers (“GUID”). The graphical connections may be saved as connector names, defined by the instance identifiers of the saved instantiated objects. It will be appreciated by those of ordinary skill in the art that the references may be stored by each connected instantiated object or by one of the connected objects, depending on the type of the connection (e.g., one-to-one, one-to-many, many-to-one or many-to-many).

If the task to be performed by the diagram is not complete 190 and does not have to be re-defined 180, in one embodiment, the method of the present invention continues with selecting blocks for inclusion in the diagram 140. In one embodiment, if the task needs to be re-defined 180, the method of the present invention continues with defining the tasks to be performed by the diagram 130. As the diagram is being constructed by instantiating blocks 150 and creating the graphical connections to establish communication among the instantiated blocks 160, the corresponding phase of the task to be performed by the diagram, if capable of being visually represented, may be made displayed on, e.g., a computer monitor, printed out, captured as a series of images, or made available by any other means to the end user.

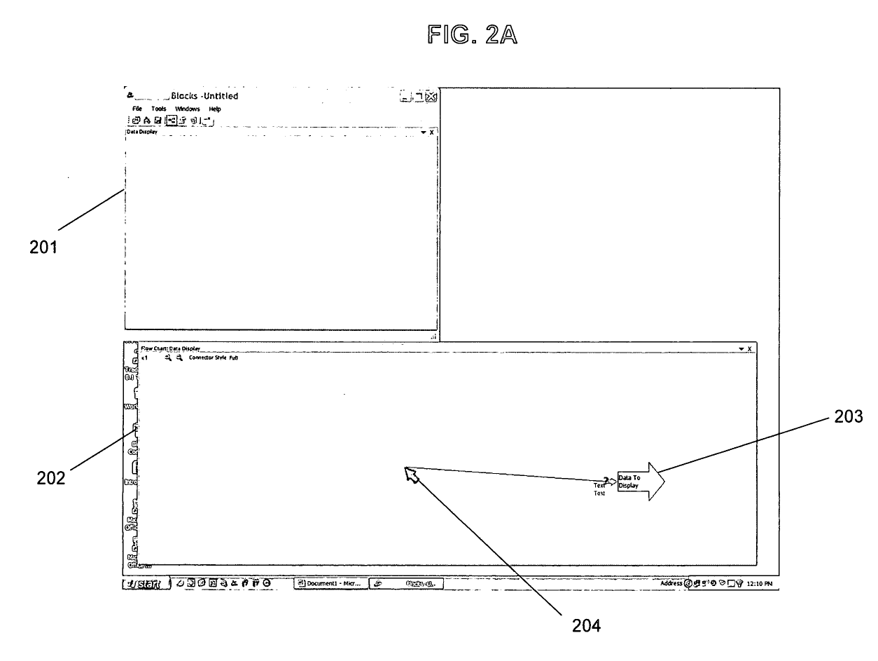

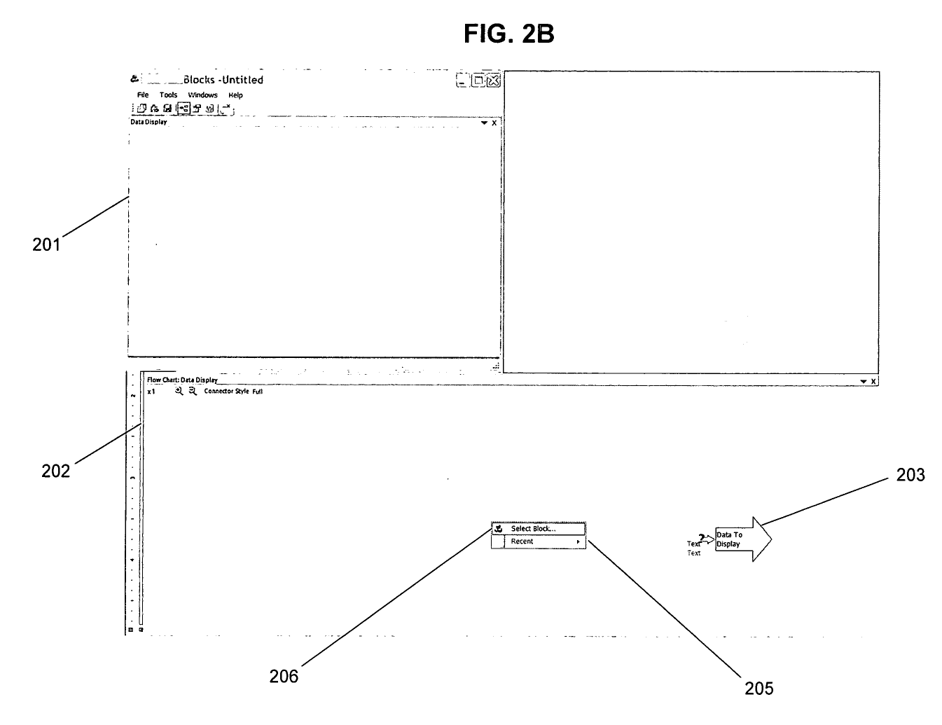

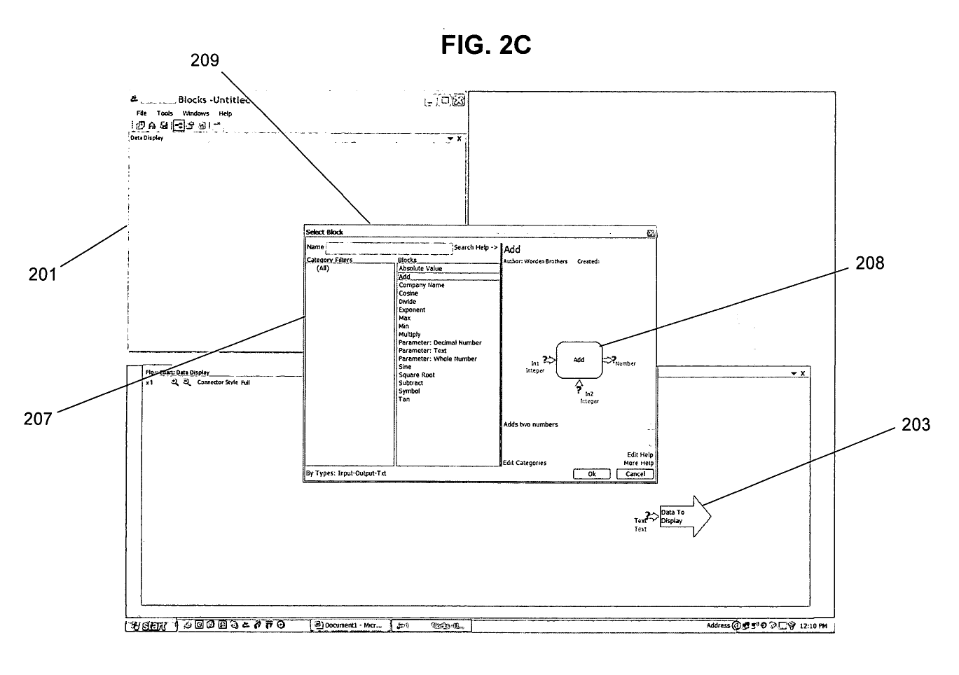

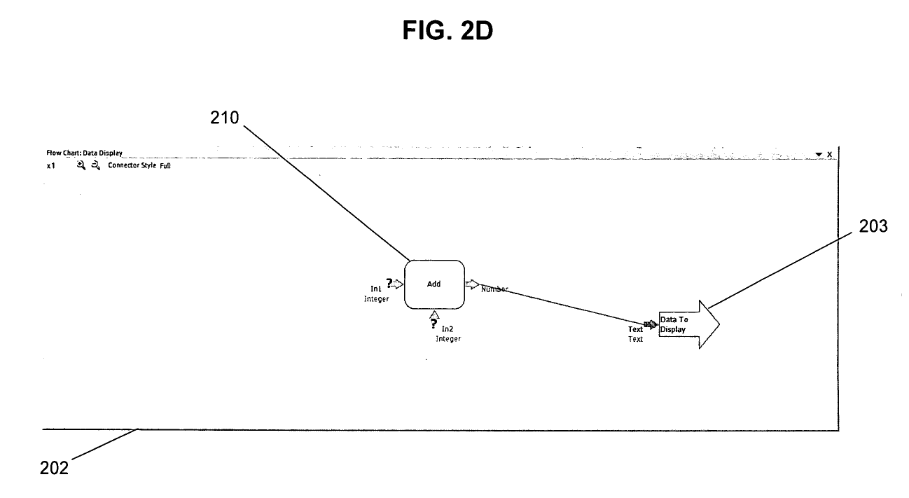

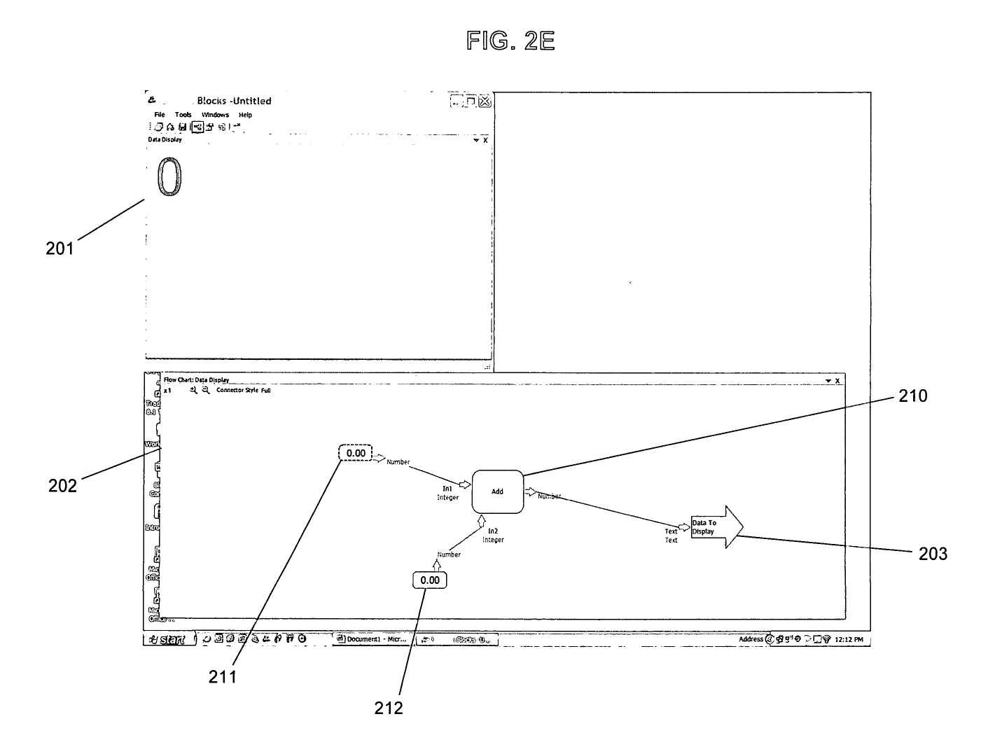

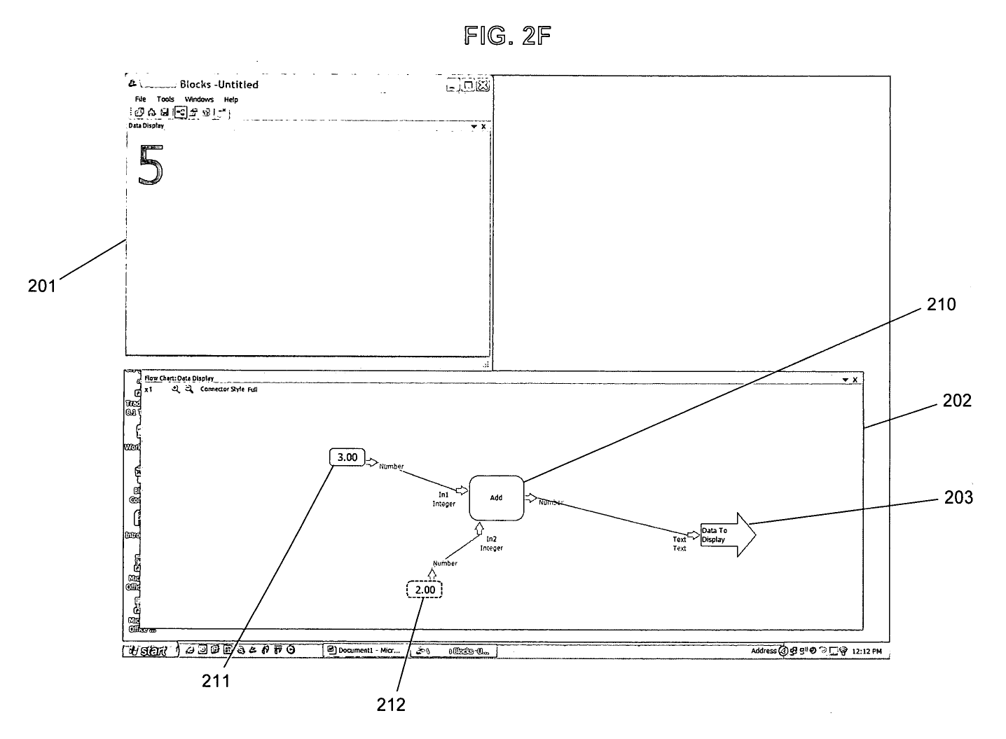

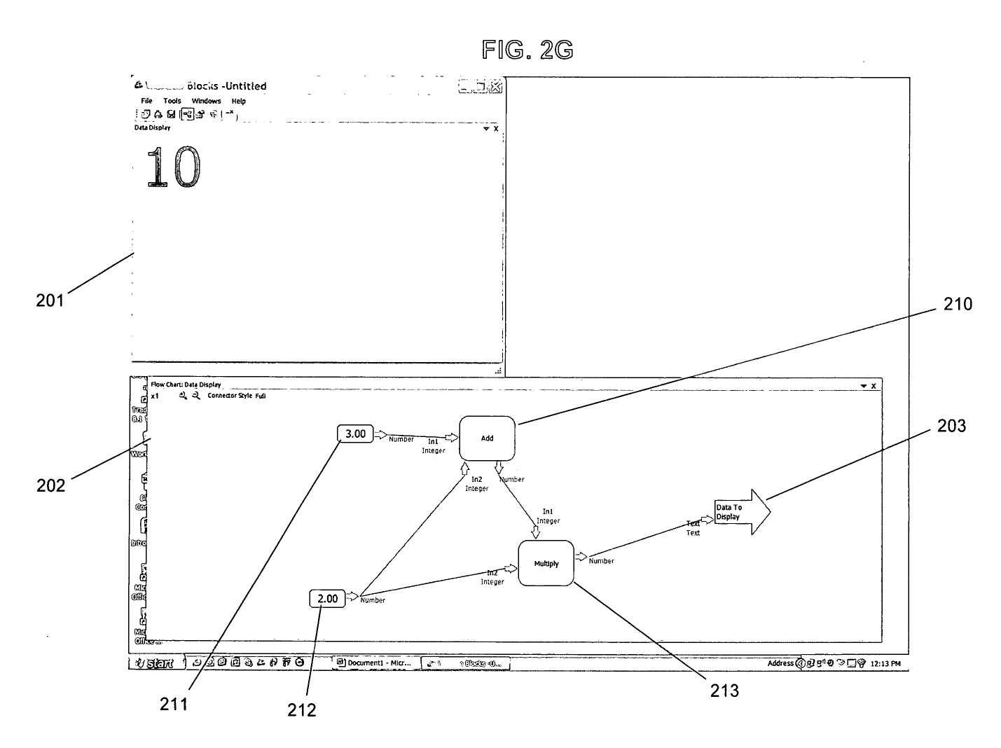

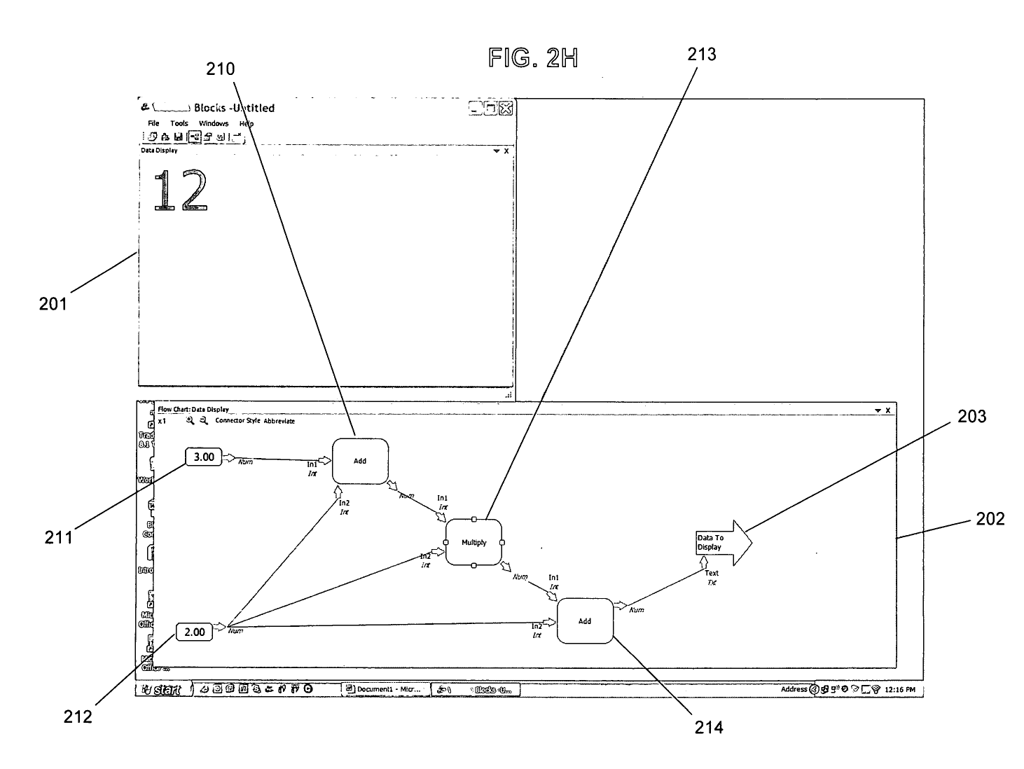

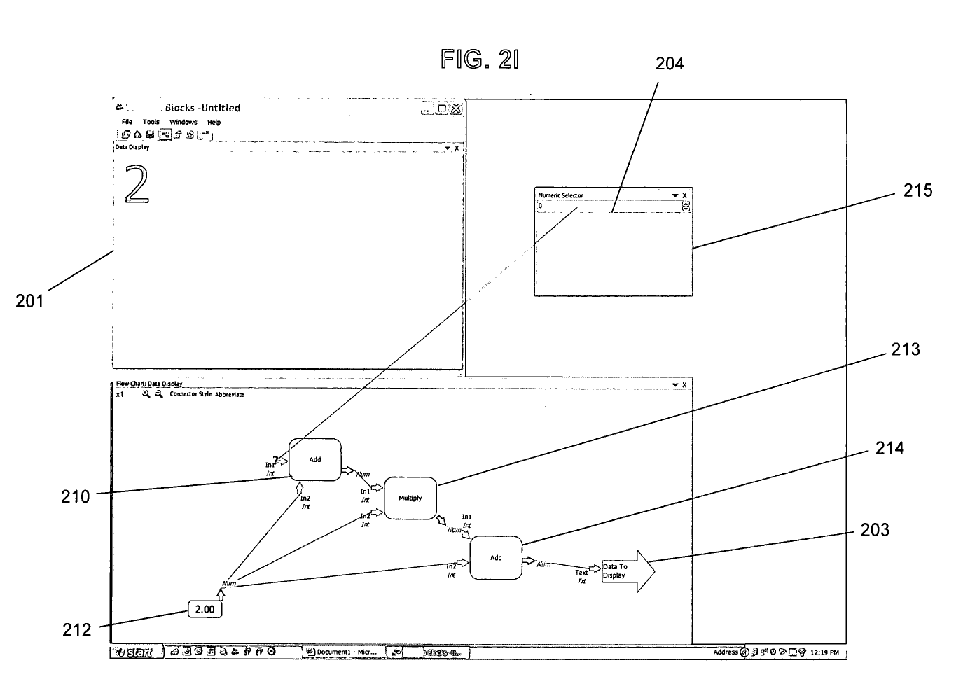

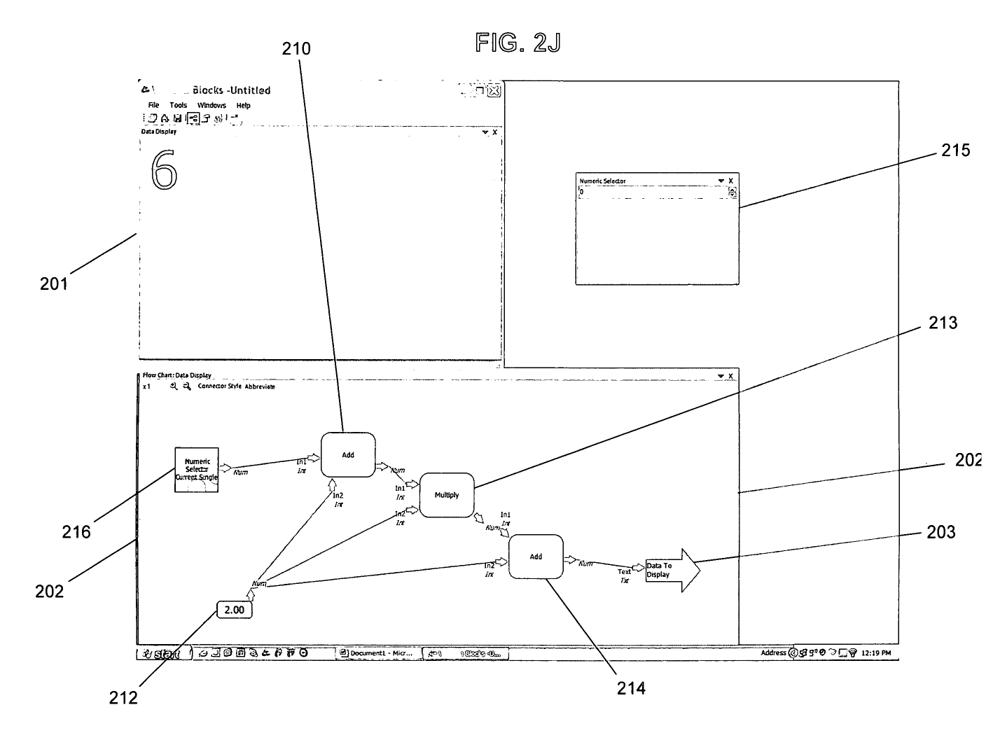

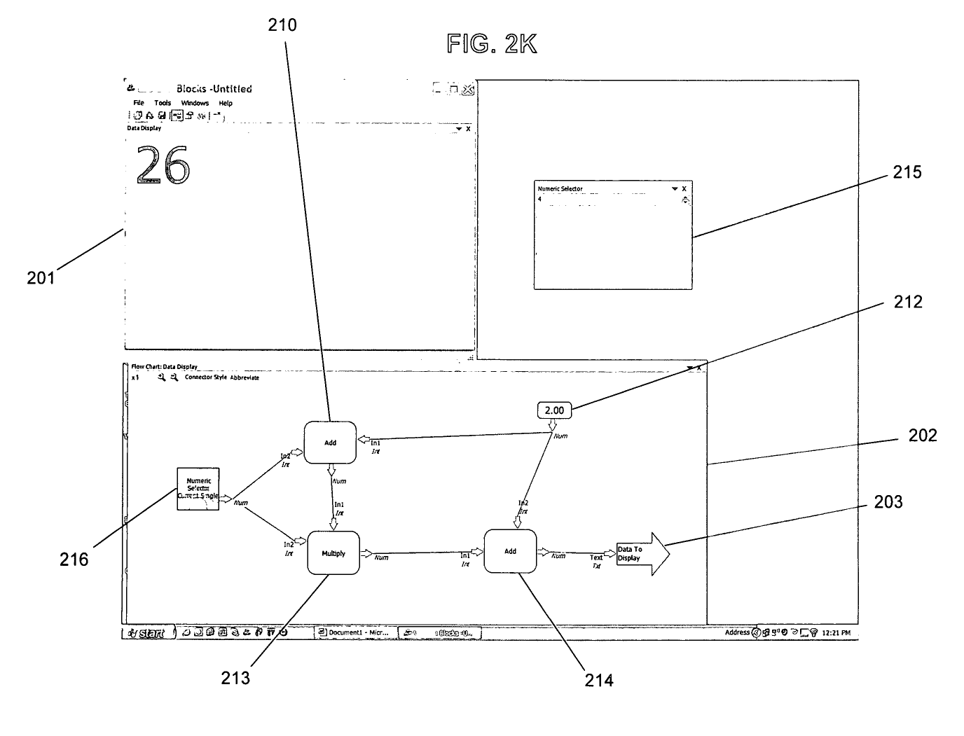

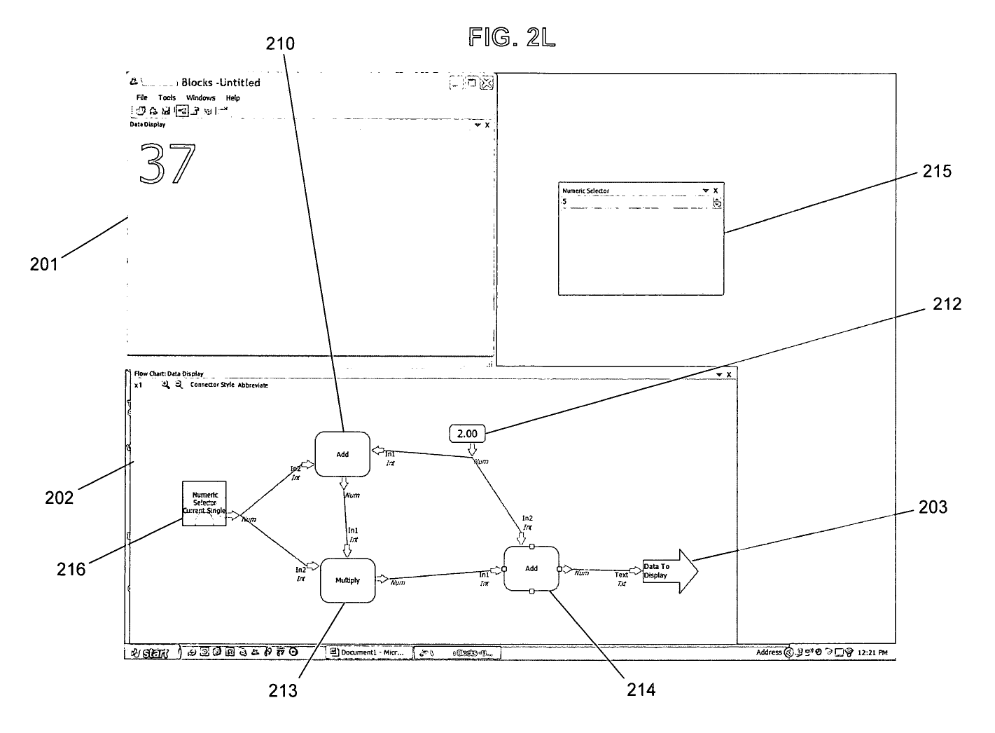

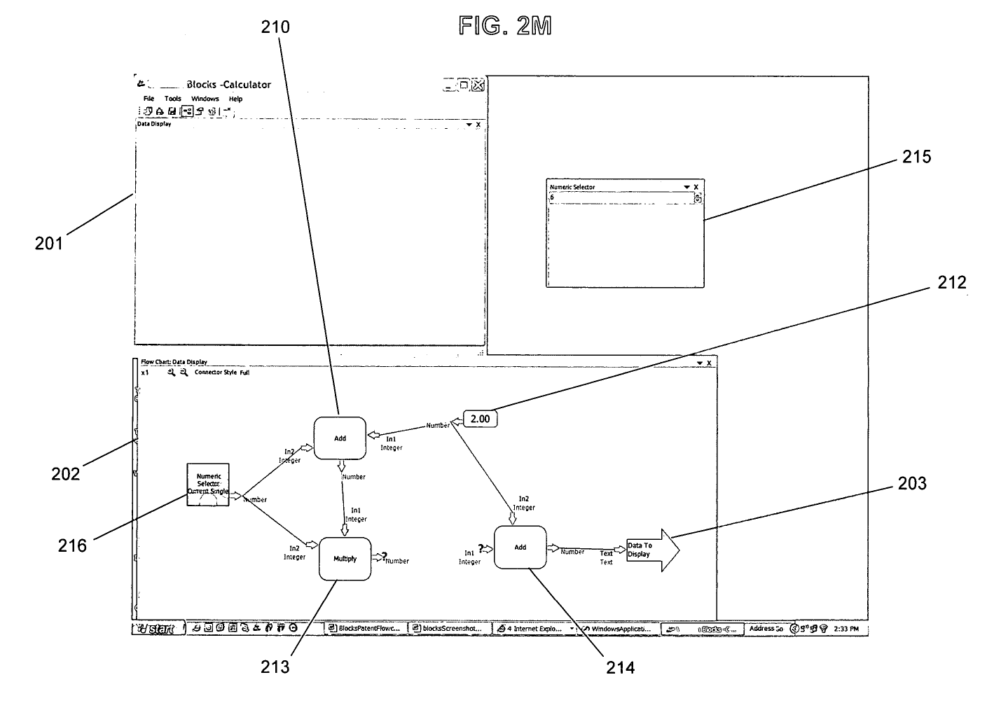

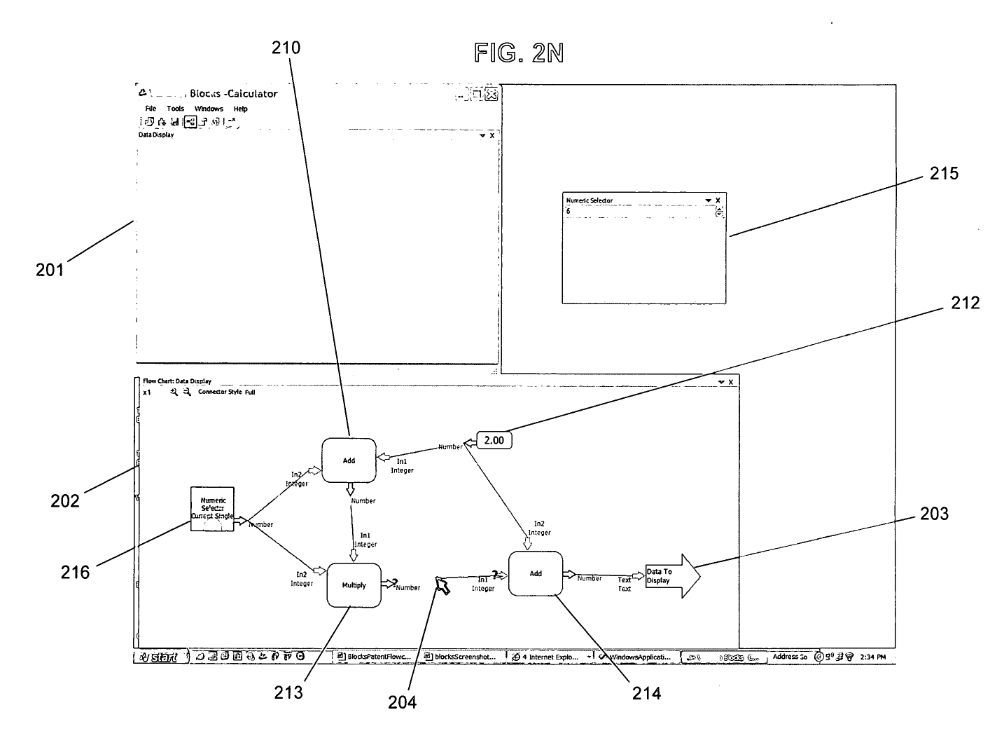

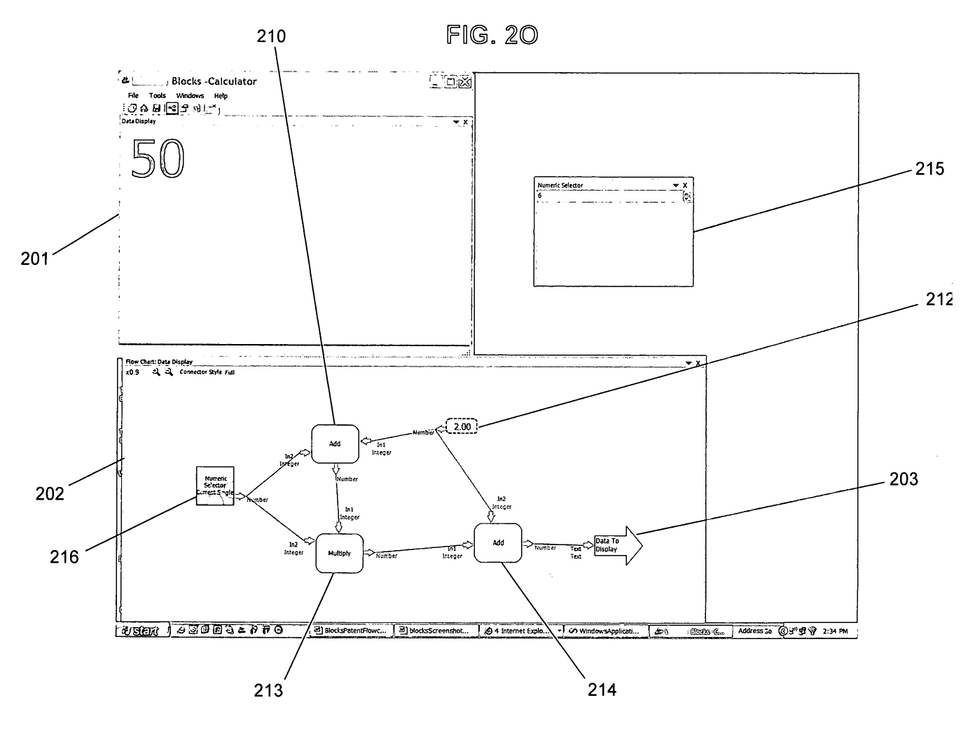

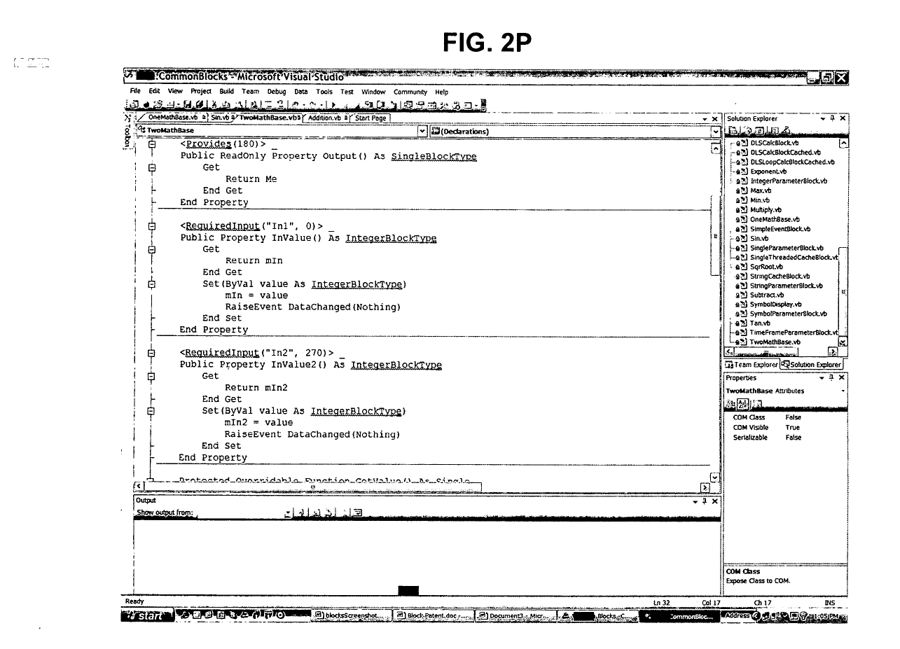

To further illustrate the operation of system of the present invention for dynamic assembly of running applications and the communications among them while running, an example scenario will now be described from the point of view of a user of the system, in reference to the GUI screens shown in FIGS. 2A-2P. In the example scenario of this embodiment, the user-defined task to be performed by a diagram is a selected function performed by a calculator.

Referring now to FIG. 2A, shown therein are two exemplary windows, a first window 202, for dynamically creating and displaying a diagram or flow chart, and a second window 201, for dynamically displaying the output 203 of the diagram as it is being created. In this embodiment, upon clicking the mouse or otherwise making a selection, represented by indicator 204 in the flow chart window 202, a block selection option 205 appears in flow chart window 202, as shown in FIG. 2B. Upon selecting the “Select Block” option 206, a third window 209 appears on the screen, containing a list 207 of available blocks (compatible classes of compiled code) for inclusion into a diagram, as shown in FIG. 2C. It will be recognized by those skilled in the art that the blocks may be categorized or grouped according to relevant factors, so that only certain categories or groups of blocks are displayed in list 207. In the example scenario shown in FIGS. 2A-2P, the list of available blocks 207 represents available compiled codes corresponding to different functions that a calculator performs, e.g., addition, subtraction, multiplication and square root, among others.

Upon scrolling down the list of available blocks 207, a graphical representation of each block 208 is shown in window 209. Assuming that the task to be performed by the diagram is addition, for example, the user may select the “Add” block 208 from list 207 (e.g., by clicking on it with a mouse), upon which the “Add” block 208 is instantiated as an object 210, as shown in FIG. 2D. The output of instantiated (alternatively referred to herein as “running” or “executing”) object 210, shown in the flow chart window 202 of FIG. 2D, is connected to the diagram output 203. It should be noted that, consistent with its function, instantiated “Add” object 210 has two inputs and one output. As shown in FIG. 2D, the two inputs are for integer numbers; however, the number format may be changed by the user if the author of “Add” block 208 has provided that the type of inputs to block 208 may be changed to different number formats.

As shown in FIG. 2E, upon graphically connecting (e.g., by using a mouse) the two inputs of instantiated object 210 to blocks 211 and 212 that provide numbers, each containing a value of 0.00, the diagram output 203, as displayed in data display window 201, is 0 (zero). When the inputs into running object 210 are changed to 3.00 and 2.00, as shown by blocks 211 and 212, respectively in FIG. 2F, the diagram output 203 immediately changes value to 5, as shown in data display window 201 of FIG. 2F.

Another example of using functions performed by a calculator will now be described in reference to FIG. 2G. In this example, the user-defined task is to calculate the result of a multiplication of two numbers, a first number and the sum of a second number and the first number. In this example, upon selection of the “Multiply” block from the list of available blocks 207 (as described above in reference to FIG. 2C), the block is instantiated into object 213, which begins to run. Upon creating the graphical connection between the output of instantiated object 210 and one input to instantiated object 213, and providing as a second input to instantiated block 213 the value in block 212, the diagram output 203 is displayed in the data display window 201, which is 10 (3.00+2.00=5.00×2.00=10), in the example shown in FIG. 2G. It should be noted that once a block is selected from the list of available blocks 207, it is instantiated into an object and begins to run, regardless of the values (or if there are no values) on its inputs and outputs. When connections are created between blocks, the thus assembled blocks continue to run, without the necessity of compiling the assembled blocks.

The process of selecting and adding blocks to the diagram, thus instantiating them into running objects, continues until the user is satisfied that the task is completed. It bears mention that each block is instantiated into a running object while the instantiated objects that have already been included in the diagram continue to run; that is, it is not necessary to stop the execution of the connected blocks prior to adding more blocks.

For example, the user may choose to redefine the task by selecting a second “Add” block 208 from the list of available blocks 207 shown in FIG. 2C. Upon selection, the second “Add” block is added as instantiated object 214, shown in FIG. 2H. Upon creating, for example, a graphical connection connecting the first input of object 214 with the output of object 213, and providing as the second input of object 214, the value of block 212, the diagram output 203 is displayed in data display window 201, in this case the value 12.

FIG. 2I shows the selection of a numeric selector block 215, and FIG. 2J shows its addition to the diagram as object 216. In FIG. 2I, dragging so as to provide a connector to the numeric selector 215 adds an existing block 216, which the numeric selector 215 has instantiated to the diagram, and connects block 216 to block 210. Therefore, the block 216 is “owned by” (e.g., provides input to) the numeric selector 215 and will always provide the current value of block 216 to selector 215.

In FIG. 2K, the value of numeric selector 215 is set to 4, and object 216 is connected to provide one input each to instantiated objects 210 and 213. The second input into instantiated object 210 is the value of block 212, while the second input into instantiated object 213 is the output of instantiated object 210. The value of block 212 is provided as one input into instantiated object 214, while the second input into instantiated object 214 is the output of instantiated object 213. Upon creating the connections, the diagram output 203, in this case 26, is displayed in data display widow 201.

FIG. 2L shows an output of 37 in data display window 201, upon changing the value of numeric selector 215 to 5. In FIG. 2M, no value is displayed in data display window 201, as the connection between instantiated objects 213 and 214 is severed. As there is only one input into instantiated object 214, the diagram does not provide an output 203, as object 214 is waiting to receive a value on its second input.

FIG. 2N shows recreating the graphical connection between instantiated objects 213 and 214 by, for example, dragging with a mouse cursor 204 from one input of instantiated object 214 to the output of instantiated object 213. It will be appreciated that nothing will be displayed in data display window 201 until the connection is complete, despite the fact that all objects shown in flow chart window 202 are instantiated and running. Upon completing the connection, however, a value of 50 is displayed in data display window 201, as shown in FIG. 20, as the value of numeric selector 215 is 6.

In one embodiment, upon establishing graphical connections among instantiated objects, references among the connected objects are established, as shown in FIG. 2P. For example, FIG. 2P shows how the connectors are defined in code. Upon creating a graphical connection, the reference provided by the output blocks simultaneously or approximately simultaneously obtains a property that is flagged to be provided, and this property is passed to the input block's set property, which has been flagged as requiring an input. A reference between the objects is thereby established.

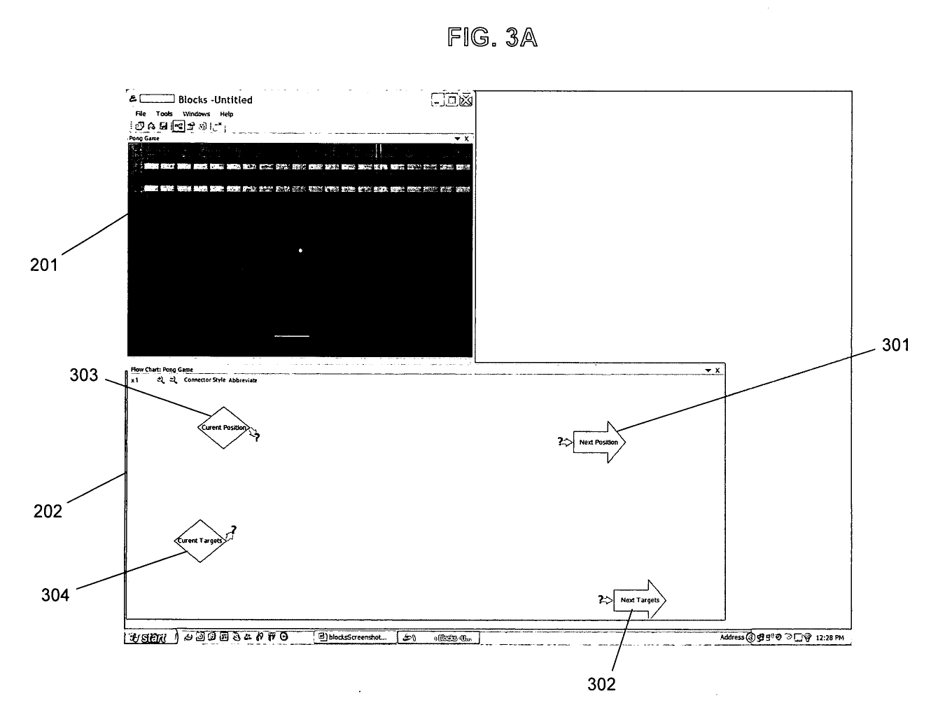

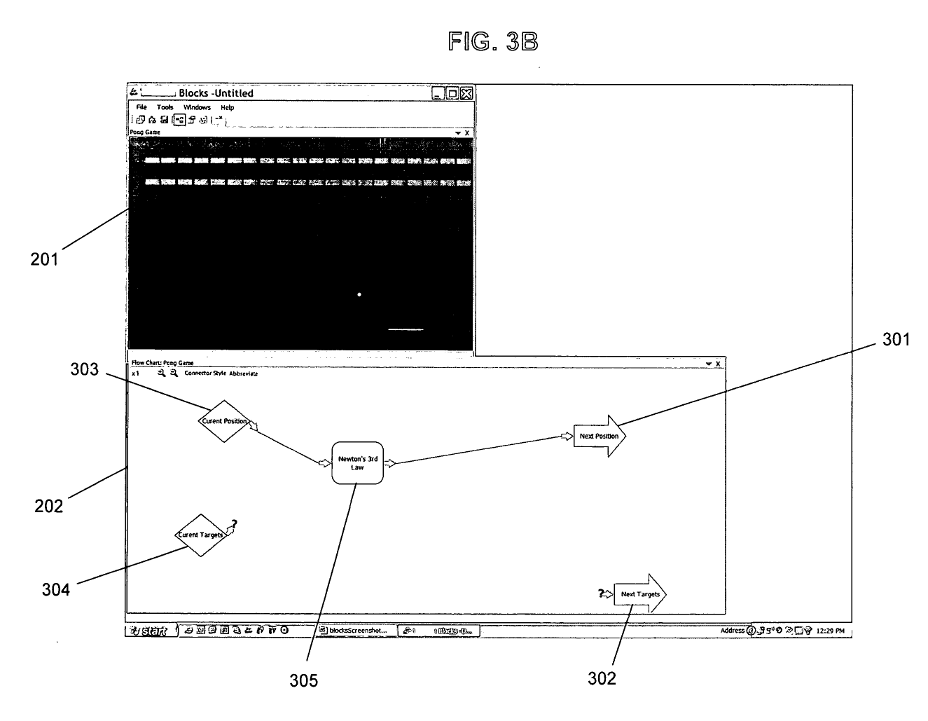

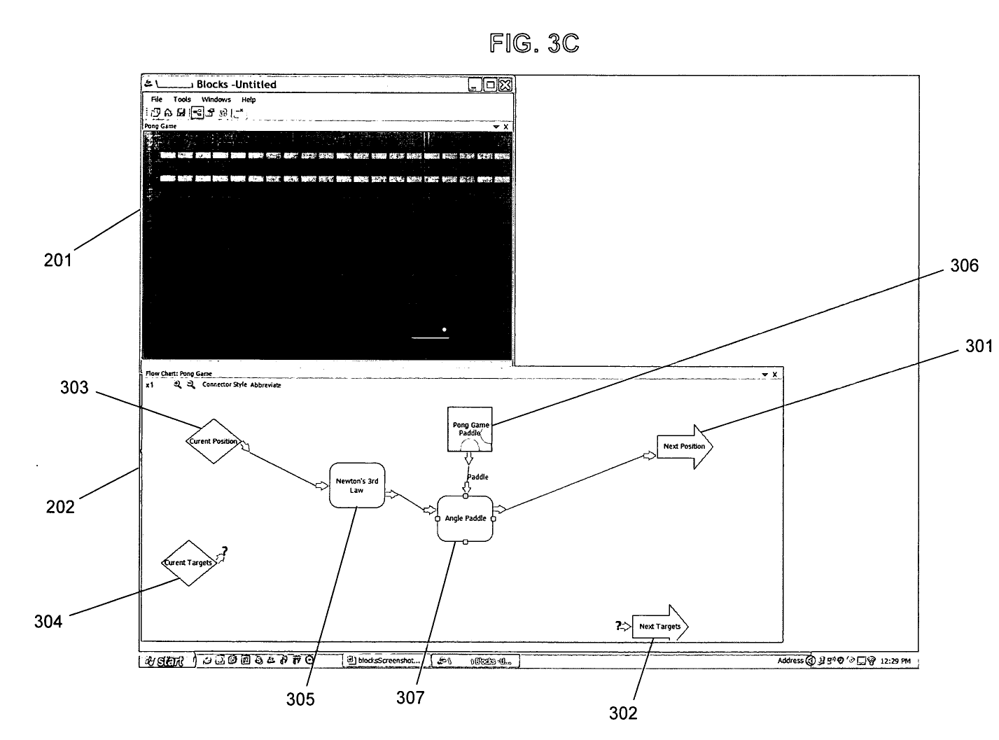

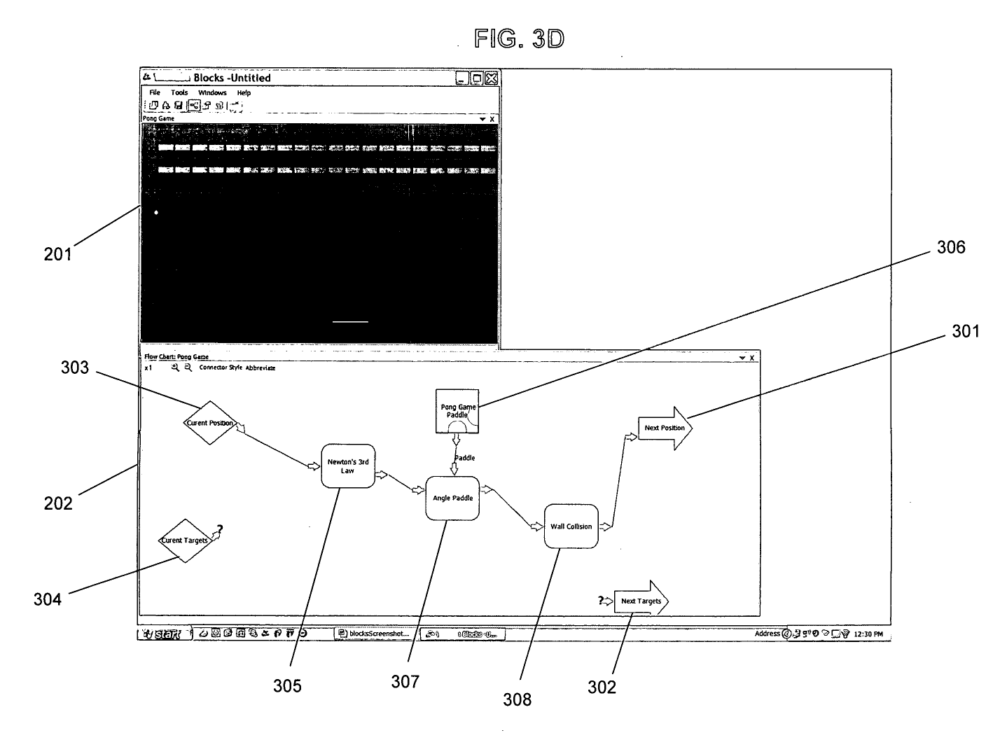

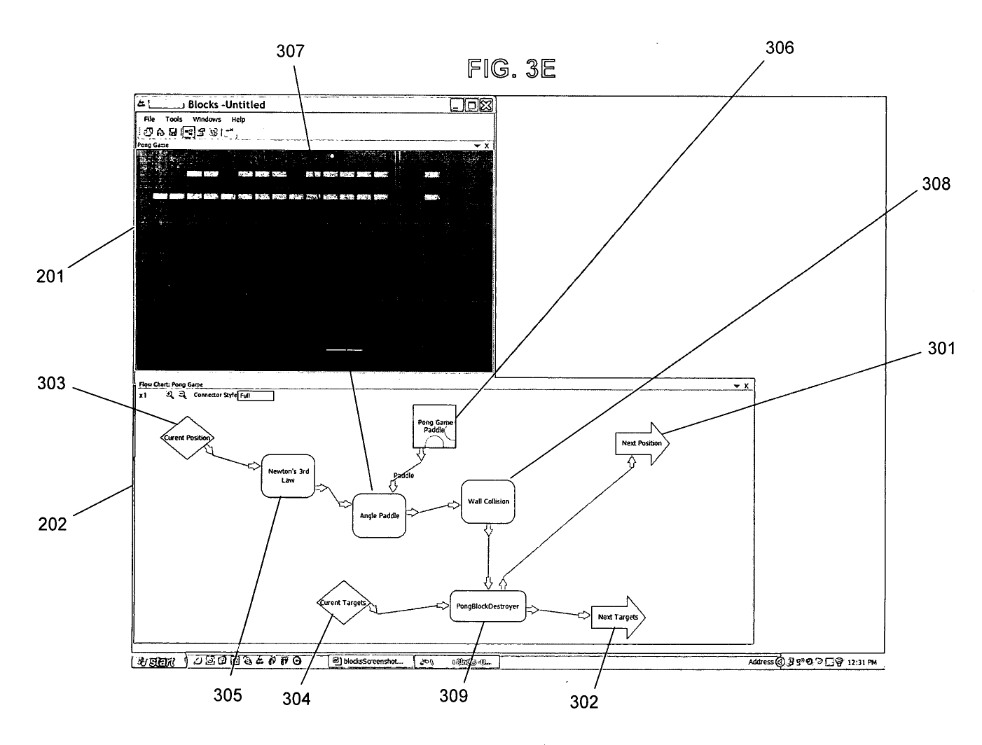

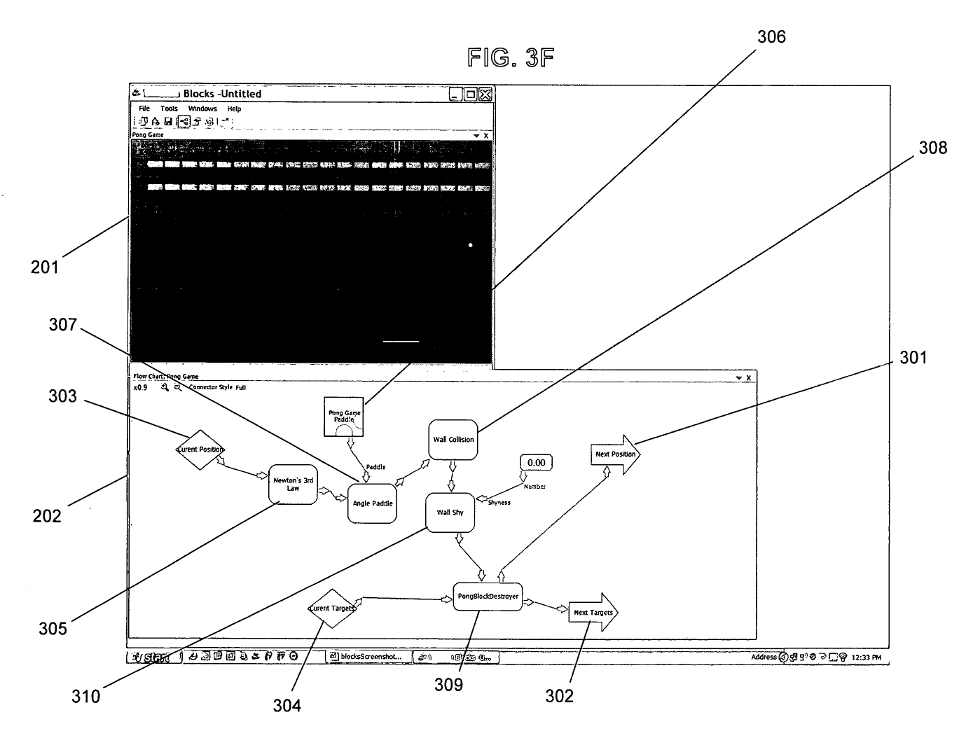

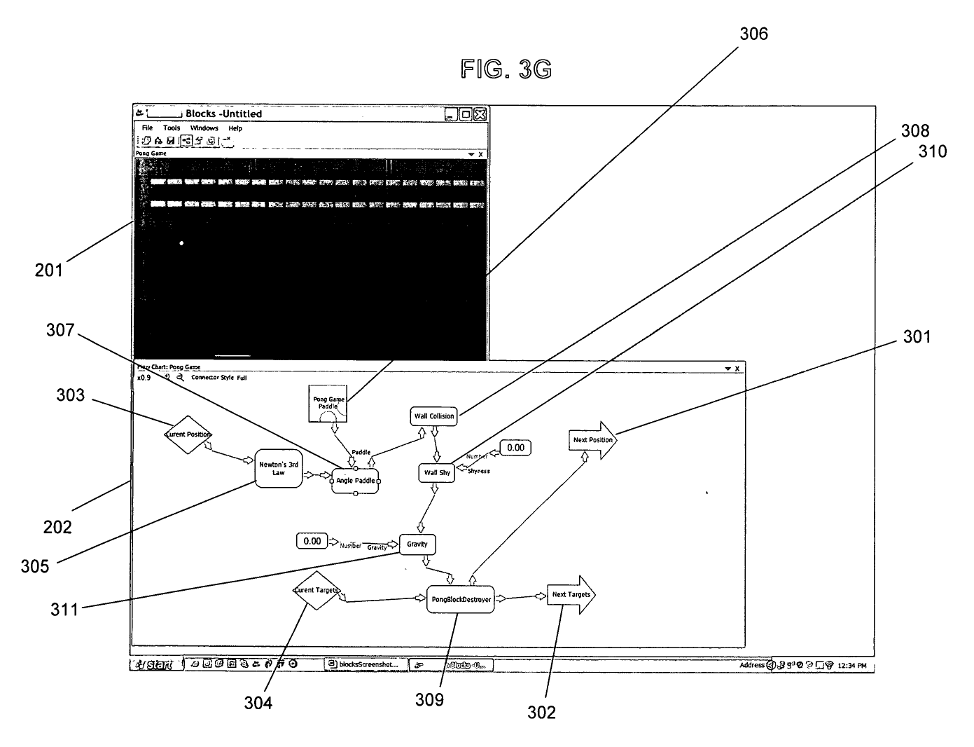

Referring now to FIGS. 3A-3G, therein shown is an example scenario for the task of performing a pong game from the point of view of a user of the system, in accordance with an embodiment of the present invention. FIG. 3A shows a screen shot prior to initiating a diagram or flow chart, and the pong ball is immobile, as shown in data display window 201. The diagram outputs 301 and 302, are respectively configured to show the next position of the pong ball and the next targets. The diagram inputs 303 and 304, are respectively configured to show the current position of the pong ball and the current targets. Upon selecting a block of code implementing a “law” to be applied (not shown), thereby instantiating this law into object 305 (here entitled “Newton's 3^{rd} Law,” which states that an object in motion remains in motion; in this example, when the game is started, the ball is provided an initial velocity vector, but does not move because it needs a block to make it move) and graphically connecting it as an output of Current Position input 303 and an input to Next Position output 301, as shown in flow chart window 202 in FIG. 3B, the pong ball in display window 201 begins to move down towards the paddle.

FIGS. 3C-3G show the progressive implementation of a pong game according to this example scenario of one embodiment of the present invention. Following the principles and procedures described above, FIG. 3C introduces a paddle 306 and an Angle Paddle instantiated object 307, which causes the pong ball to bounce off the paddle; FIG. 3D introduces Wall Collision instantiated object 308, which causes the pong ball to bounce off the walls; FIG. 3E introduces PongBlockDestroyer instantiated object 309, connected to the output of Current Targets input 304 and the input of Next Targets output 302, which causes the pong ball to destroy bricks it comes into contact with (and bounce off of them), as shown in data display window 201; and FIGS. 3F and 3G introduce Wall Shy and Newton's 3^{rd} Law instantiated objects 310 and 311, each of which respectively causes the pong ball to become accelerated/delayed by a variable factor when approaching the bottom or the walls shown in data display window 201.

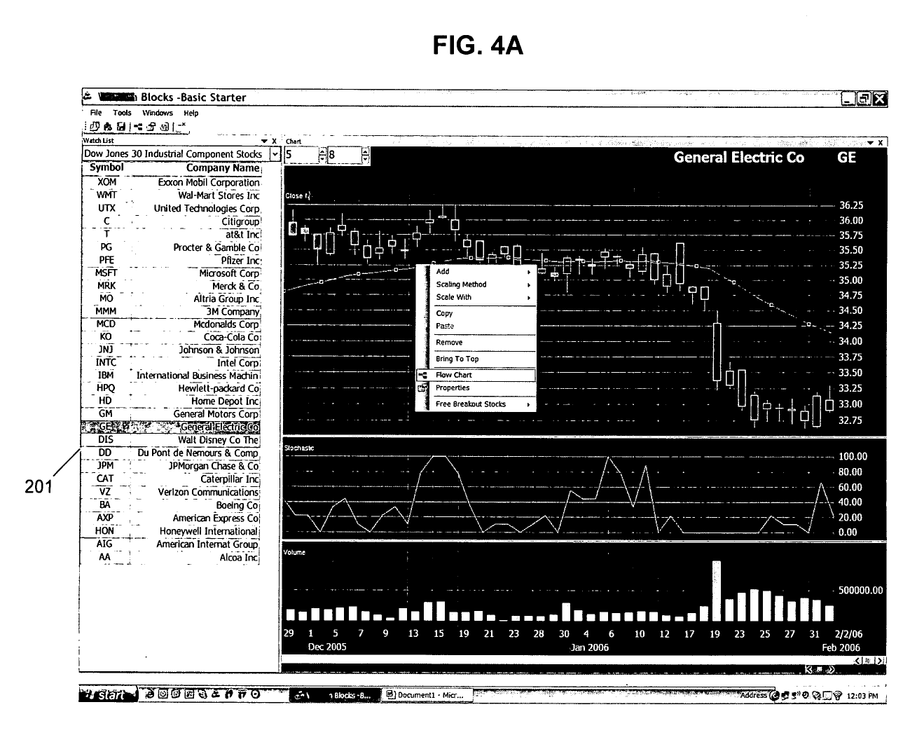

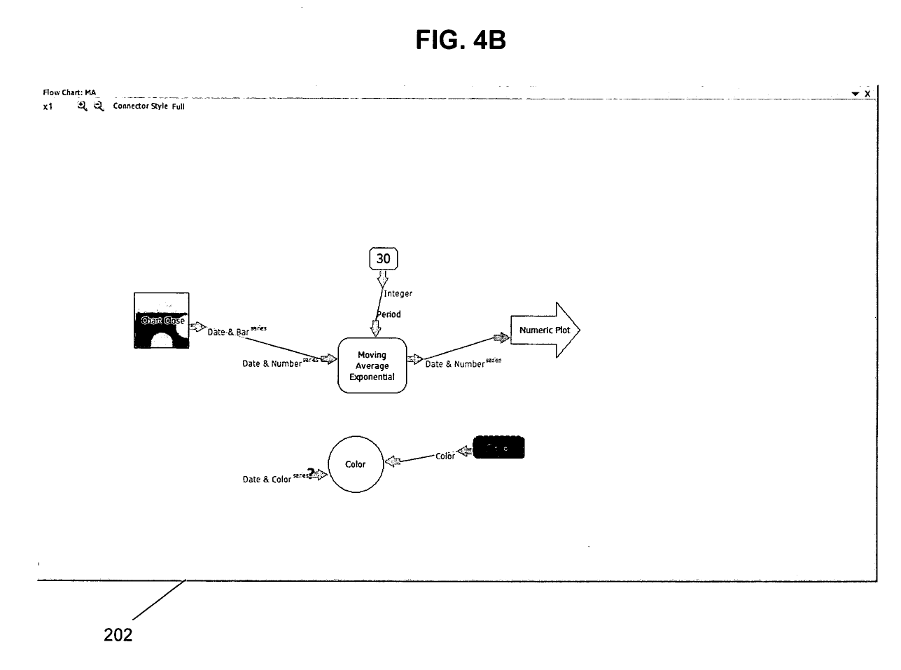

Referring now to FIGS. 4A and 4B, therein shown is an example scenario for the task of creating a statistical stock chart, in accordance with an embodiment of the present invention. FIG. 4A depicts the data display window showing variations of user-selected stocks according to user-selected criteria (e.g., minimum, maximum, average, and median values, with such values being provided once an hour, once a day, every two days, or at any selected interval). The exemplary diagram shown in flow chart window 202 in FIG. 4B causes the results displayed in the data display window 201, shown in FIG. 4A.

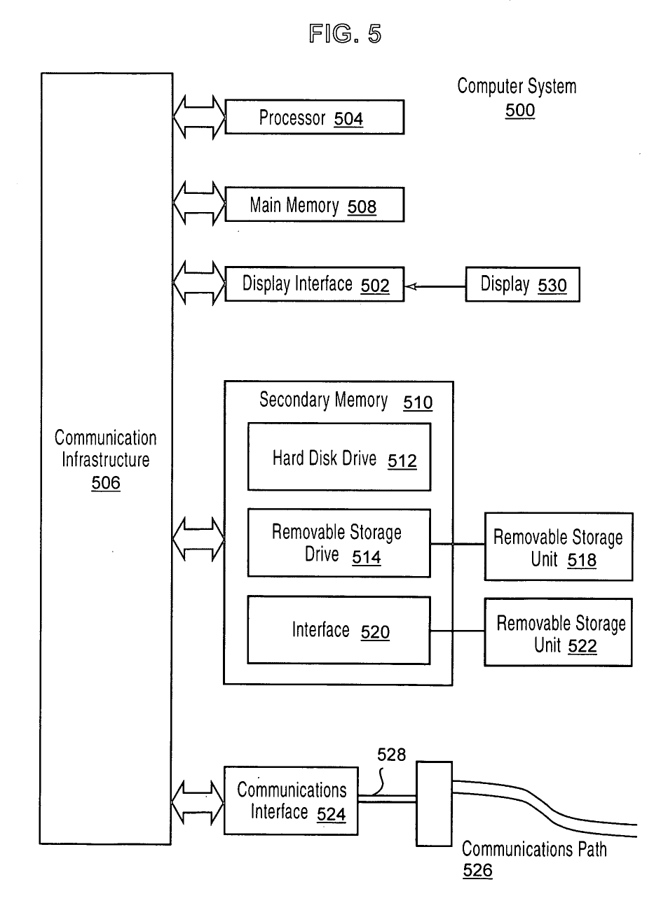

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 500 is shown in FIG. 5.

Computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530. Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518, represents a floppy disk, magnetic tape, optical disk, etc., which is read by and written to removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 514, a hard disk installed in hard disk drive 512, and signals 528. These computer program products provide software to the computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512, or communications interface 524. The control logic (software), when executed by the processor 504, causes the processor 504 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

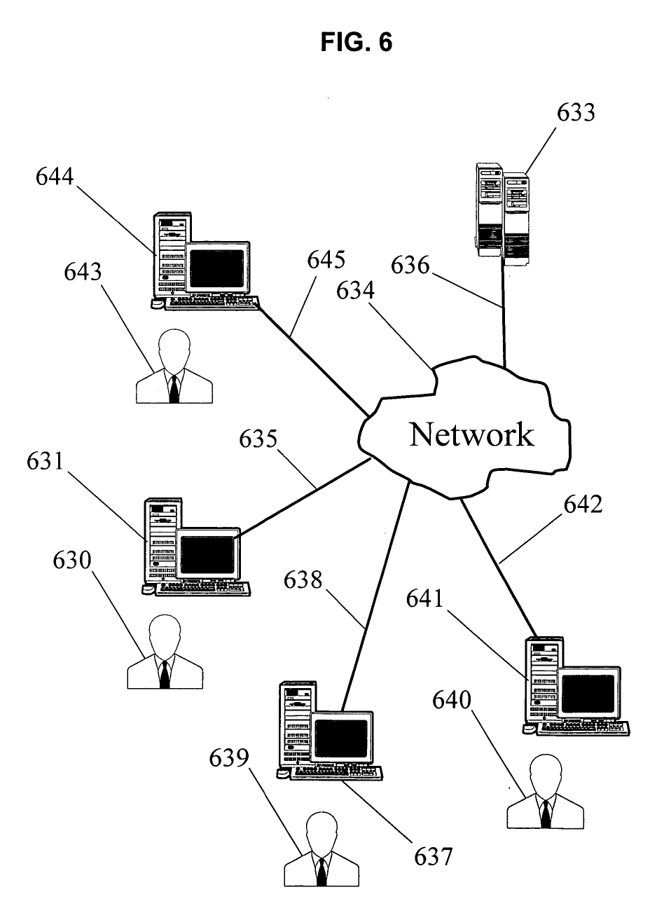

FIG. 6 presents an exemplary system diagram of various hardware components and other features in accordance with an embodiment of the present invention. As shown in FIG. 6, in an embodiment of the present invention, each source code author 630, 639 and 640 creates a stand alone source code application, and makes it available, via network 634, to user 643. User 643, via the system of the present invention residing on terminal 644, creates a flow chart by connecting the source codes provided by users 630, 639 and 640. The terminal 644 is coupled to a server 633, on which portions of the data used by the created flow chart are stored, via a network 634, such as the Internet, via couplings 635, 636.

Each of the terminals 631, 637, 641, 644 is, for example, a personal computer (PC), minicomputer, mainframe computer, microcomputer, telephone device, personal digital assistant (PDA), or other device having a processor and input capability. The terminal 631 is coupled to a server 633, such as a PC, minicomputer, mainframe computer, microcomputer, or other device having a processor and a repository for data or connection to a repository for maintained data.

In one exemplary embodiment, the system for dynamic assembly of running applications and the connections among them while running may be implemented, for example, as a Microsoft.net® desktop application program (Microsoft.net® is made by Microsoft® Corporation of Redmond, Wash.), which may reside on a computer hard drive, database or other repository of data, or be uploaded from the Internet or other network (e.g., from a personal computer (PC), minicomputer, mainframe computer, microcomputer, telephone device, personal digital assistant (PDA), or other device having a processor and input capability). It will be recognized by those skilled in the art, however, that any available software tool capable of implementing the concepts described herein may be used to implement the system and method of the present invention.

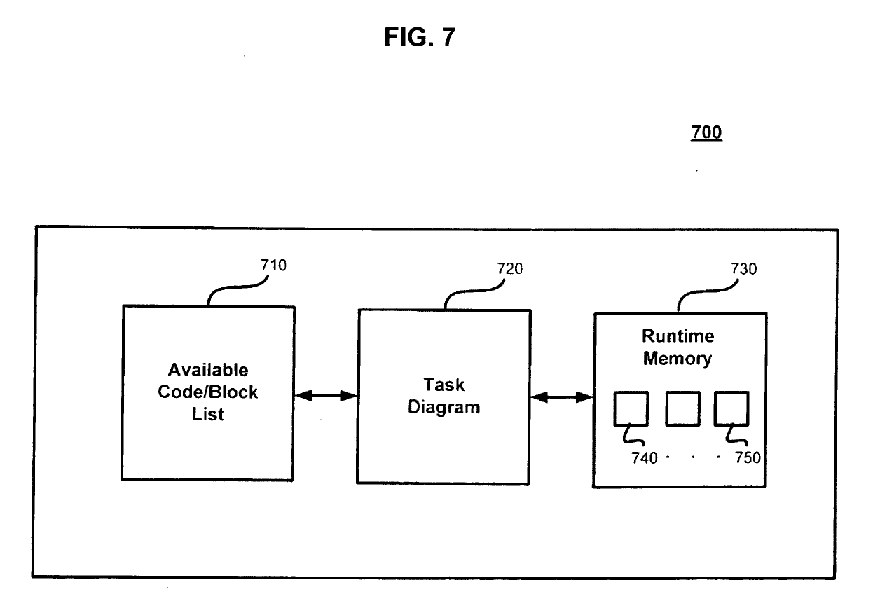

One embodiment of the present invention is based on an open system architecture 700, as shown in FIG. 7. In this embodiment, the system for dynamic assembly of running applications and the connections among them while running includes an Available Code/Block List module 710, a Task Diagram module 720, and a Runtime Memory module 730. After identifying a task to be performed, a user selects the blocks needed to complete the task, instantiates these blocks into running objects 740 . . . 750 in Running Memory module 730, while adding them to Task Diagram Module 720 and creating graphical connections to enable communications among the instantiated objects to complete the task while the objects are running, and without causing interruption in program execution.

In one embodiment, the end user of the method and system of the present invention may be the ultimate consumer of data created as a result of the functioning of the system, such as a data analyst. An end user of the system, in another embodiment, may be a programmer, who creates flow charts based on the blocks that are available to the system. In yet another embodiment, the end user may be a user that provides the data to the system of the present invention, to be processed and manipulated by others. Those of ordinary skill in the art will appreciate the unlimited spectrum of end users of the system and method of the present invention.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

1. A method for graphical assembly of running applications, the method comprising:
selecting first and second components of compiled code for inclusion in the diagram;
instantiating the selected first component of compiled code into a first object and instantiating the selected second component of compiled code into a second object upon inclusion of the selected first component and the selected second component in the diagram; and
creating at least one user defined graphical connection among the instantiated objects to enable communication among the instantiated objects.

2. The method of claim 1, wherein the first and second components of compiled code are selected from a plurality of available classes of compiled code.

3. The method of claim 1, further comprising:
defining at least one task to be performed via a diagram, wherein each of the defined at least one task is performed in real time.

4. The method of claim 1, wherein each of the at least one user defined graphical connection comprises object references.

5. The method of claim 1, wherein each of the at least one user defined graphical connection is created without generating new code.

6. A method for graphical assembly of running applications, the method comprising:
receiving a selection of first and second components of compiled code for inclusion in the diagram;
instantiating the selected first component into a first object and instantiating the selected second component into a second object upon inclusion of the selected first component and the selected second component in the diagram; and
receiving a selection to create at least one user defined graphical connection among the instantiated objects to enable communication among the instantiated objects.

7. The method of claim 6, wherein the first and second components of compiled code are selected from a plurality of available classes of compiled code.

8. The method of claim 6, further comprising:
receiving a selection of at least one task to be performed via a diagram, wherein each of the selected at least one task is performed in real time.

9. The method of claim 6, wherein each of the at least one user defined graphical connection comprises object references.

10. The method of claim 6, wherein each of the at least one user defined graphical connection is created without generating new code.

11. A method of saving assemblies of running applications and references thereamong as diagrams, the method comprising:
creating one or more user defined graphical connections among a plurality of instantiated objects to establish one or more object references;
saving each of the instantiated objects and graphical connections in a data repository; and
re-instantiating the saved instantiated objects and graphical connections at a selected time.

12. The method of claim 11, wherein each of the instantiated objects and graphical connections is saved in Extensible Markup Language (XML) format.

13. The method of claim 11, wherein each of the instantiated objects is saved as an instance identifier.

14. The method of claim 12, wherein the instance identifier is a Globally Unique Identifiers (GUID).

15. The method of claim 13, wherein each of the graphical connections is saved as a connector name, the connector name being defined by the instance identifier of the saved instantiated object.

16. The method of claim 15, wherein the connector name is a pointer to an execution address.

17. The method of claim 15, wherein the connector name is a method name.

18. The method of claim 15, wherein the connector name is a user defined name.

19. A method for graphically managing running applications at runtime, the method comprising:
accessing a list of a plurality of classes of compatible compiled code, a corresponding plurality of classes of compatible code being accessible via the list;
enabling each of the plurality of classes to be available as one or more blocks for inclusion in a diagram;
receiving a definition of a task to be performed by the diagram;
receiving a selection of at least two of the one or more blocks for inclusion in the diagram;
receiving a selection of a user defined graphical connection among the at least two selected blocks; and
establishing a reference among the at least two selected blocks upon receiving the selection of the user defined graphical connection;
wherein upon inclusion in the diagram, each block appears as a graphically represented instantiated object, the selected blocks appearing as a plurality of graphically represented instantiated objects.

20. The method of claim 19, wherein the selected blocks comprise a diagram.

21. The method of claim 19, wherein the user defined graphical connection is selected via a user input device.

22. The method of claim 19, wherein the reference enables communication among the plurality of graphically represented instantiated objects.

23. The method of claim 22, wherein each reference is storable via each of the corresponding graphically connected instantiated objects.

24. The method of claim 22, wherein at least one of the graphically instantiated objects corresponding to the at least two selected blocks is able to facilitate brokering of the reference among the corresponding graphically connected instantiated objects.

25. The method of claim 19, wherein enabling each of the plurality of classes to be available as one or more blocks for inclusion in a diagram includes:
locating the plurality of classes of compiled code, each of the plurality of classes having metadata; and
evaluating the metadata of each of the plurality of classes to determine compatibility with the metadata of each other one of the plurality of classes.

26. The method of claim 19, wherein enabling each of the plurality of classes to be available as one or more blocks for inclusion in a diagram includes:
locating the plurality of classes of compiled code; and
attempting to load pairs of the plurality of classes into a memory to determine compatibility among each loaded pair of the plurality of classes.

27. A system for graphical assembly of running applications, the system comprising:
means for receiving a selection of first and second components of compiled code for inclusion in the diagram;
means for instantiating the selected first component into a first object and instantiating the selected second component into a second object upon inclusion of the selected first component and the selected second component in the diagram; and
means for receiving a selection to create at least one user defined graphical connection among the instantiated objects to enable communication among the instantiated objects.

28. A system for graphical assembly of running applications, the system comprising:
a processor;
a user interface functioning via the processor, the user interface including a mechanism for receiving selections from a user; and
a repository accessible by the processor;
wherein a selection of first and second components of compiled code for inclusion in the diagram is received;
wherein the selected first component is instantiated into a first object and wherein the selected second component is instantiated into a second object upon inclusion of the selected first component and the selected second component in the diagram; and
wherein a selection to create at least one user defined graphical connection among the instantiated objects to enable communication among the instantiated objects is received.

29. The system of claim 28, wherein the processor is housed on a terminal.

30. The system of claim 29, wherein the terminal is selected from a group consisting of a personal computer, a minicomputer, a main frame computer, a microcomputer, a hand held device, and a telephonic device.

31. The system of claim 28, wherein the processor is housed on a server.

32. The system of claim 31, wherein the server is selected from a group consisting of a personal computer, a minicomputer, a microcomputer, and a main frame computer.

33. The system of claim 31, wherein the server is coupled to a network.

34. The system of claim 33, wherein the network is the Internet.

35. The system of claim 33, wherein the server is coupled to the network via a coupling.

36. The system of claim 35, wherein the coupling is selected from a group consisting of a wired connection, a wireless connection, and a fiberoptic connection.

37. The system of claim 28, wherein the repository is housed on a server.

38. The system of claim 37, wherein the server is coupled to a network.

39. A computer program product comprising a computer usable medium having control logic stored therein for causing a computer to graphically assemble running applications, the control logic comprising:
first computer readable program code means for receiving a selection of first and second components of compiled code for inclusion in the diagram;
second computer readable program code means for instantiating the selected first component into a first object and instantiating the selected second component into a second object upon inclusion of the selected first component and the selected second component in the diagram; and
third computer readable program code means for receiving a selection to create at least one user defined graphical connection among the instantiated objects to enable communication among the instantiated objects.

40. A method for graphical assembly of executing software, the method comprising:
receiving a selection of at least two components of compiled code for inclusion in a graphical representation; and
receiving a selection of a user defined graphical connection among the at least two selected components of compiled code;
wherein, upon inclusion in the graphical representation, the at least two components of compiled code appear as corresponding graphically represented executing instantiated objects; and
wherein, upon receiving the selection of the user defined graphical connection, at least one reference is established among the corresponding graphically represented executing instantiated objects.

41. The method of claim 40, wherein the at least one reference enables communication among the corresponding graphically represented executing instantiated objects.

42. The method of claim 40, wherein the selection of the at least two components of compiled code is made from a plurality of available classes of compiled code.

43. The method of claim 40, wherein each of the at least one reference is established without generating new code.
